(19) United States
(12) Patent Application Publication
(10) Pub. No.: US 2025/0131904 A1
(43) Pub. Date: Apr. 24, 2025

(54) HEARING AID FOR LEISURE SPORTS

(71) Applicants: Bumjoon Cha, Seongnam-si (KR); Hyegyo Cha, Seongnam-si (KR)

(72) Inventors: Bumjoon Cha, Seongnam-si (KR); Hyegyo Cha, Seongnam-si (KR)

(21) Appl. No.: 18/491,025

(22) Filed: Oct. 20, 2023

(51) Int. Cl. G10K 11/08; H04R 1/10

(52) U.S. Cl. CPC G10K 11/08; H04R 1/1008; H04R 2420/07

(57) ABSTRACT

The present disclosure relates to a hearing aid for leisure sports, and the hearing aid for leisure sports may include: a covering part having a concave accommodation space formed therein to accommodate a user's ear in such a way to allow a front-end portion facing the user's riding direction to be located in front of the user's ear, a covering part having an opening formed on a rear-end portion located over an ear to collect sound waves from behind the user to the accommodation space; and a wearing part for fixing the covering part to the user's ear.

### BACKGROUND OF THE DISCLOSURE

### Field of the Disclosure

The present disclosure relates to a hearing aid for leisure sports, more specifically to a hearing aid for leisure sports that is capable of being configured to be easily worn on a user's ear, minimizing the noise generated by the wind blowing in front of the user, and allowing sounds behind the user to be more clearly heard so that the user recognizes warnings and potential hazards and safely handles a traffic situations behind the user which cannot be recognized visually.

### Background of the Related Art

Generally, extreme leisure sports, such as cycling, mountain biking, inline skating, and others, are enjoyed with the adrenalin rush that comes from high speeds, and recently, as organizations for common leisure sports become popular, the number of participants in leisure sports increased.

Riders of bicycles, inline skates, and etcetera wear various protective equipment, such as helmets and knee pads, before playing their leisure sports, and such protective equipment is used for the purpose of inhibiting individuals from injuries during their ride.

Further, an individual playing a leisure sport, such as cycling and inline skating, enjoys a sense of speed while he or she is enjoying the sport, and during the process where the rider moves forward, wind collides against the front of his or her face and his or her ears.

In the process, noise generated when the wind collides against the ears is directly transmitted to the rider, and while the rider is affected by the noise generated from the wind, the rider must continue riding. As a result, it is possible that the rider's auditory functions may be deteriorated in the long run, and further, it is hard for the rider to audibly recognize the traffic situations behind the rider which cannot be recognized visually, thereby causing the rider to be exposed to risks of traffic accidents due to vehicles coming behind him or her.

Further, as listening to music became recently common, riders also wear earphones to enjoy music while riding, and accordingly, it is difficult to hear music coming from the earphones due to the noise generated by the wind. Also, with safety risks occurring in an environment where concise visual awareness is not existent, it is preferred that the riders do not listen to music or talk on the phone for their road safety.

### SUMMARY OF THE DISCLOSURE

Accordingly, the present disclosure has been made in view of the above-mentioned problems occurring in the related art, and it is an object of the present disclosure to provide a hearing aid for leisure sports that is capable of being configured to be easily worn on a user's ear, minimizing the noise generated by the wind blowing toward the user's face, which makes the user insensitive to other sound sources related to a traffic condition, and allowing sounds behind the user to be more clearly transmitted to the user's ear, which improves the user's auditory sensitivity to the visually unseen surrounding environments, and thus, the hearing aid for leisure sports ensures the user's road safety.

To accomplish the above-mentioned objective, according to the present disclosure, the provided hearing aid for leisure sports includes: a covering part having a concave accommodation space formed therein to accommodate a user's ear in such a way to allow a front-end portion facing the user's riding direction to be located in front of the user's ear, a covering part having an opening formed on a rear-end portion located above the ear to induce sound waves to the accommodation space; and a wearing part for fixing the covering part to the user's ear.

According to the present disclosure, desirably, an inner surface of the covering part may have a parabolic shape to reflect the sound waves onto a single focus that is set in position to correspond to the user's earhole.

According to the present disclosure, desirably, the covering part may be configured to allow the opening to be located on a space behind the user's earflap when the covering part is worn on the user's ear.

According to the present disclosure, desirably, the covering part may include a slant or streamlined curved-shape on an outer surface to minimize the resistance of the wind blowing toward the user's face.

According to the present disclosure, desirably, the covering part may have the shape of a semi-dome on an outer surface thereof such that the front-end portion facing the user's riding direction thereof is curved and the rear-end portion thereof is open.

According to the present disclosure, desirably, the wearing part may include a first coupler for fixing the covering part to protective equipment worn on the user's body.

According to the present disclosure, desirably, the first coupler may include clips connected to a fixing strap of a helmet worn on the user's body.

According to the present disclosure, desirably, the clips may be spaced apart from each other in up and down directions.

According to the present disclosure, desirably, the first coupler may further include position-adjusting members adapted to adjust the clips in position on the covering part in forward and backward directions.

According to the present disclosure, desirably, the first coupler may include soft coupling members each having a coupling hole fitted to a leg of glasses worn on the user's ear.

According to the present disclosure, desirably, the wearing part may include a second coupler for fixing the covering part to the user's earflap.

According to the present disclosure, desirably, the second coupler may include an elastic band whose both ends are connected to the top and bottom ends of the rear-end portion of the covering part.

According to the present disclosure, desirably, the second coupler may include a hook pivotably coupled to a top side of the rear-end portion of the covering part.

According to the present disclosure, desirably, the hearing aid may further include a wireless speaker located on the inner surface of the covering part.

### BRIEF DESCRIPTION OF THE DRAWINGS

The above and other objects, features and advantages of the present disclosure will be apparent from the following detailed description of the preferred embodiments of the present disclosure in conjunction with the accompanying drawings, in which:

FIG. 1 is a perspective view showing a hearing aid for leisure sports according to a first embodiment of the present disclosure;

FIG. 2 is a side view showing a state where the hearing aid for leisure sports according to the present disclosure is worn on a user;

FIGS. 3A and 3B are graphs showing simulation results of computational fluid dynamics before and after the hearing aid for leisure sports according to the present disclosure is worn;

FIG. 4 is a sectional view showing a worn state of the hearing aid for leisure sports according to the present disclosure;

FIGS. 5A and 5B are side views showing states where clip positions are adjusted on the hearing aid for leisure sports according to the present disclosure;

FIG. 6 is a perspective view showing a hearing aid for leisure sports according to a second embodiment of the present disclosure;

FIG. 7 is a perspective view showing a hearing aid for leisure sports according to a third embodiment of the present disclosure; and

FIG. 8 is a sectional view showing a state where a wireless speaker is mounted on the covering part of the hearing aid for leisure sports according to the present disclosure.

### DETAILED DESCRIPTION OF THE PREFERRED EMBODIMENTS

Before the description, for reference numerals, with respect to the same elements even though they may be displayed in different drawings, such elements use same reference numerals as much as possible, and they will be explained in a first embodiment of the present disclosure. Further, explanations of different elements of other embodiments from those of the first embodiment will be given.

Hereinafter, an explanation of a hearing aid for leisure sports according to a first embodiment of the present disclosure will be given in detail with reference to the attached drawings.

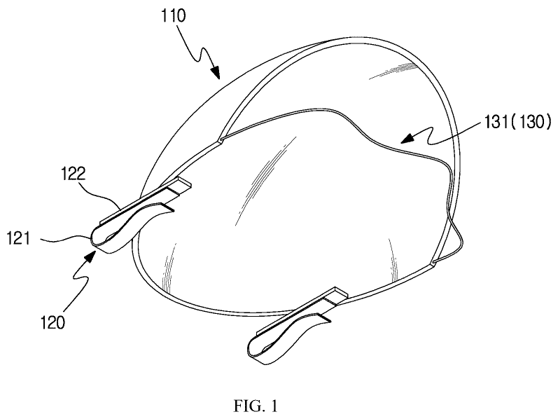

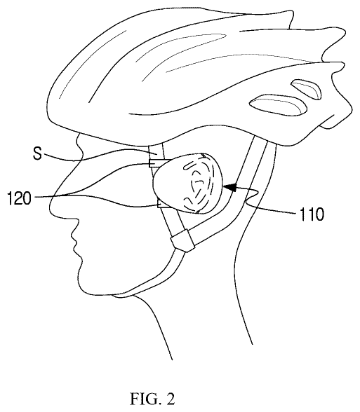

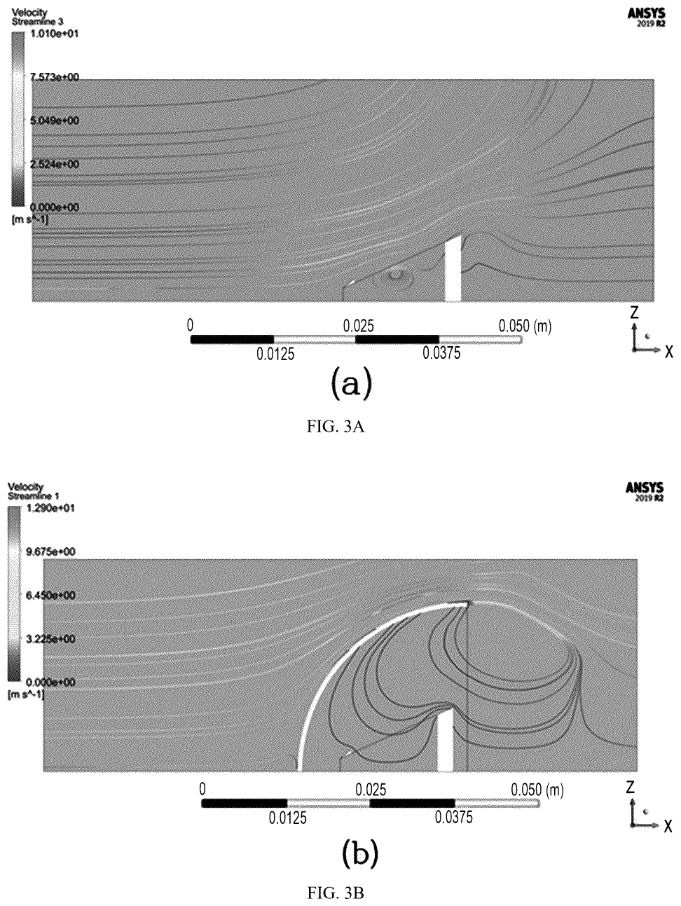

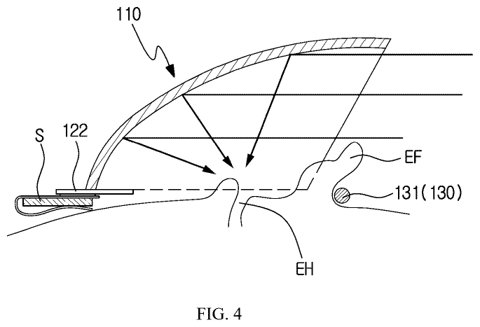

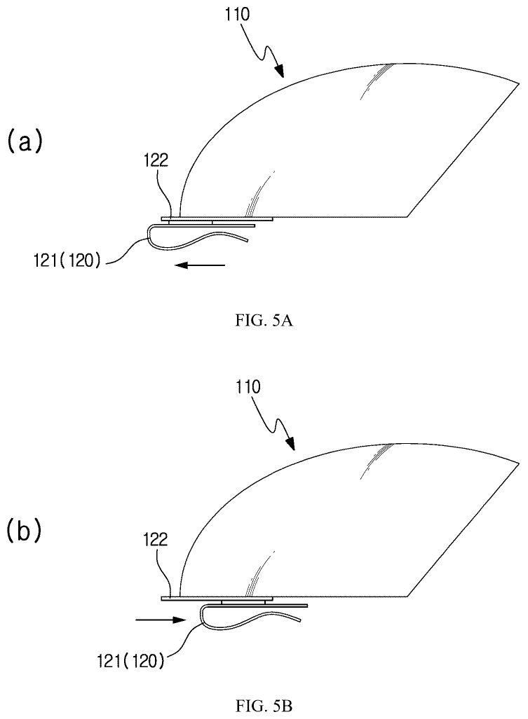

FIG. 1 is a perspective view showing a hearing aid for leisure sports according to a first embodiment of the present disclosure. FIG. 2 is a side view showing a state where the hearing aid for leisure sports according to the present disclosure is worn on a user. FIGS. 3A and 3B are graphs showing simulation results of computational fluid dynamics before and after the hearing aid for leisure sports according to the present disclosure is worn. FIG. 4 is a sectional view showing a worn state of the hearing aid for leisure sports according to the present disclosure, and FIGS. 5A and 5B are side views showing states where clip positions are adjusted on the hearing aid for leisure sports according to the present disclosure.

A hearing aid for leisure sports according to the first embodiment of the present disclosure is provided in the form of a pair of hearing aids worn on both ears of a user, and each hearing aid includes a covering part 110 for covering the corresponding ear and a wearing part for fixing the covering part 110 to protective equipment worn on the user or to the user's body region.

The covering part 110 has the shape of a semi-dome that is curved on the outer surface of the front-end portion facing a user's riding direction and open on the rear-end portion thereof in a state of covering the user's ear, while having a concave accommodation space to accommodate the user's ear.

The covering part 110 is worn on the user's ear such that the curved front-end portion thereof is located on the side in front of the ear and the open rear-end thereof is located on the space behind the earflap EF.

The covering part 110 has the shape of the semi-dome to minimize the resistance of the wind blowing toward the user's face.

FIGS. 3A and 3B show the simulation results of computational fluid dynamics (CFD) for checking the reduction of the noise caused by the wind, and in this case, the air velocity around the ear is 10 m/s for a user riding at a speed of about 36 km/s.

FIG. 3A shows a state where no cover is worn on the ear, and in this case, it is found that vortexes are formed in a concave portion of the ear. Since the air velocity of the vortexes is about 2.5 m/s, it is found that noise is generated due to the vortexes formed to the user's earhole EH. Contrarily, FIG. 3B shows a state where the covering part 110 is worn on the ear, and in this case, it is found that the air flows naturally along the outer surface of the covering part 110 covering the ear behind the ear, and since the air velocity generated inside the covering part 110 is close to 0 m/s, the noise generated due to the wind is significantly reduced.

Moreover, the opening formed on the rear-end portion of the covering part 110 serves as a receiver to collect sound waves from behind the user, and as shown in FIG. 4, the inner surface of the covering part 110 has a parabolic shape, capable of reflecting the sound waves onto a single focus. In this case, the position of the focus is set to correspond to the earhole EH.

Accordingly, the wind blowing toward the user's face flows naturally behind the ear along the outer surface of the covering part 110, thereby minimizing the noise generated by the wind blowing toward the user's face, and because the sound waves from behind the user, collected by the interior of the accommodation space through the opening, are reflected onto the earhole EH of the user, thereby improving the user's auditory sensitivity to the visually unseen surrounding environments.

According to the present disclosure, further, the exemplary embodiment where the covering part 110 has the shape of the semi-dome is explained, but it is possible that the outside of the covering part 110 has a slant or streamlined curved shape capable of minimizing the resistance of the wind blowing toward the user's face.

The wearing part serves to fix the covering part 110 to the ear and has at least one of a first coupler 120 for fixing the covering part 110 to protective equipment worn on the user's body and a second coupler 130 for fixing the covering part 110 to the user's earflap EF.

The first coupler 120 has clips 121 coupled to a fixing strap S of a helmet worn on the user. Each clip 121 is made of a metal or plastic material having elasticity, and in a state where one side of the clip 121 is fixed to the covering part 110, the clip 121 is elastically fixed to the fixing strap S of the helmet. The elasticity of the clip 121 is set to such a degree that the clip 121 is not arbitrarily separated from the fixing strap S in a state of being fixed to the fixing strap S, and the clip 121 is pulled by the user's hand and easily separated from the fixing strap S.

The clips 21 are spaced apart from each other in up and down directions to stably fix the covering part 110 to the fixing strap S, and the first coupler 120 further includes position-adjusting members 122 each disposed between the covering part 110 and the corresponding clip 121 to support the clip 121 in such a way to allow the clip 121 to be adjusted in position in forward and backward directions.

For example, each position-adjusting member 122 includes a rail disposed on the covering part 110 in a direction parallel to the moving direction of the clip 121 and a movable block sliding along the rail in a state of fixing the clip 121 thereto, and desirably, the position-adjusting member 122 is configured to inhibit the clip 121 from arbitrarily moving in position after the clip 121 has been adjusted in position.

Accordingly, it is possible that the covering part 110 is adjusted in position correspondingly to a distance between the fixing strap S and the ear, and the respective clips 121 are movable to the corresponding positions to the fixing strap S as a coupling object thereto.

The second coupler 130 includes an elastic band 131 whose both ends are connected to the top and bottom ends of the rear-end portion of the covering part 110. The elastic band 131 serves to fix the rear-end portion of the covering part 110 to the earflap EF and has a given length so that the elastic band 131 is elastically wound on the rear side of the earflap EF in a state where the ear is covered with the covering part 110.

That is, the front-end portion of the covering part 110 is fixed to the fixing strap S of the helmet by means of the first coupler 120, and the rear-end portion thereof to the earflap EF by means of the second coupler 130, thereby inhibiting the set position of the covering part 110 from being arbitrarily changed or avoiding the covering part 110 being released arbitrarily from the state where the ear is covered with the covering part 110.

Now, an explanation of operations of the hearing aid for leisure sports according to the first embodiment of the present disclosure will be given.

The clips 121 of the first coupler 120 are located on the top and bottom of the front-end portion of the covering part 110 and the elastic band 131 of the second coupler 130 on the rear-end portion of the covering part 110.

As shown in FIGS. 2 and 4, the pair of clips 121 disposed on the front-end portion of the covering part 110 is coupled to the fixing strap S of the helmet, and the elastic band 131 disposed on the rear-end portion of the covering part 110 is fixedly wound on the rear side of the earflap EF, so that the covering part 110 is worn on the user's ear.

That is, the front-end portion of the covering part 110 is fixed to the fixing strap S of the user's helmet by means of the first coupler 120 having the clips 121, and the rear-end portion thereof to the earflap EF by means of the second coupler 130 having the elastic band 131, thereby inhibiting the covering part 110 from being arbitrarily separated from the fixing strap S while being worn on the user's ear.

As the outer edge of the front-end portion of the covering part 110 worn on the user's ear has the shape of the half-dome, the covering part 110 allows the wind blowing toward the user's face to flow to the space behind the user's ear, thereby minimizing the noise generated by the wind (See FIGS. 3A and 3B).

Further, the opening is formed on the rear-end portion of the covering part 110, and the inner surface of the covering part 110 coming in contact with the accommodation space to accommodate the ear has a parabolic shape, capable of reflecting the sound waves onto a single focus. Accordingly, since the sound waves transmitted to the accommodation space formed at the inside of the covering part 110 through the opening of the rear-end portion of the covering part 110 are reflected on the focus corresponding to the earhole EH from the inner surface of the covering part 110, the user's auditory sensitivity to the visually unseen environments behind the user can be improved to help the user recognize warnings or dangers and cope with the user's surrounding environments (See FIG. 4).

Further, the clips 121 disposed on the top and bottom of the front-end portion of the covering part 110 are adjustable in position in the forward and backward directions by means of the position-adjusting members 122. That is, the clip 121 disposed on top of the covering part 110 is movable forward, as shown in FIG. 5A, and the clip 121 disposed on the bottom of the covering part 110 is movable backward, as shown in FIG. 5B. Therefore, it is possible that the covering part 110 is coupled to fixing straps S having various types and shapes.

Next, an explanation of a hearing aid for leisure sports according to a second embodiment of the present disclosure will be given.

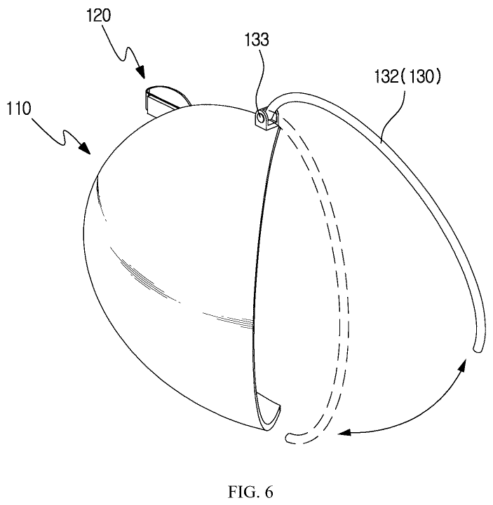

FIG. 6 is a perspective view showing the hearing aid for leisure sports according to the second embodiment of the present disclosure.

As shown in FIG. 6, the hearing aid for leisure sports according to the second embodiment of the present disclosure is different from that according to the first embodiment of the present disclosure in that the second coupler 130 has a hook 132 pivotably coupled to the top side of the rear-end portion of the covering part 110 through a rotation shaft 133.

The top end of the hook 132 is pivotably coupled to the top side of the rear-end portion of the covering part 110 by means of the rotation shaft 133. In a state where the hook 132 rotates to a closing side (downward), accordingly, the hook 132 grasps the back of the earflap EF to allow the covering part 110 to be fixed to the earflap EF, and in a state where the hook 132 rotates to an open side (upward), contrarily, the covering part 110 is separated from the earflap EF.

Moreover, even though not shown in the drawings, fixing members are desirably disposed on the bottom of the hook 132 and a bottom side of the rear-end portion of the covering part 110 to fix the bottom of the hook 132 to the bottom side of the rear-end portion of the covering part 110 in the state where the hook 132 rotates to the closing side, thereby preventing the position of the hook 132 to the closing side from being arbitrarily moved. For example, the fixing members are formed of a pair of permanent magnets, such as a combination of a magnet and a magnetic material.

Next, an explanation of a hearing aid for leisure sports according to a third embodiment of the present disclosure will be given.

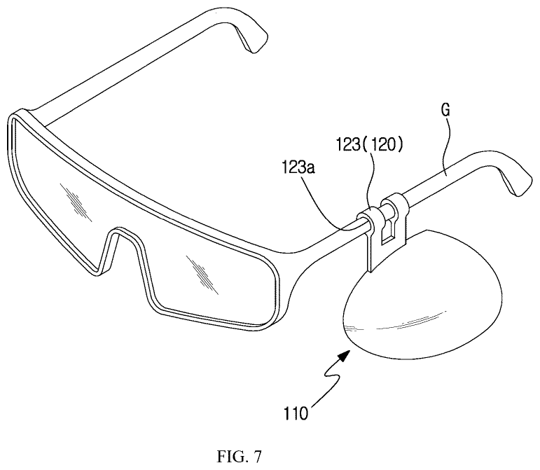

FIG. 7 is a perspective view showing the hearing aid for leisure sports according to the third embodiment of the present disclosure.

As shown in FIG. 7, the hearing aid for leisure sports according to the third embodiment of the present disclosure is different from that according to the first embodiment of the present disclosure in that the first coupler 120 includes soft coupling members 123 each having a coupling hole 123a fitted to a leg G of glasses worn on the user's ear.

The coupling members 123 are made of soft materials, such as rubber and silicone, and accordingly, the coupling holes 123a are elastically contractable. To provide stable coupling forces, the coupling members 123 are spaced apart from each other along the longitudinal direction of the leg G of glasses.

That is, as shown in FIG. 7, if the leg G of the glasses passes through the coupling holes 123a of the coupling members 123, the coupling holes 123a are elastically contracted and fixed to the leg G of glasses, and in this case, the coupling members 123 slide along the longitudinal direction of the leg G of the glasses so that the covering part 110 is adjusted in position in the forward and backward directions.

Even though not shown in the drawings, a position adjusting member may be located between the coupling members 123 and the covering part 110 to adjust the positions of the coupling members 123 in the upward and downward directions.

That is, as the coupling members 123 coupled to the leg G of the glasses slide along the leg G of the glasses, the covering part 110 is adjusted in position in the forward and backward directions, and further, the covering part 110 is adjusted in position in the upward and downward directions through the position-adjusting member disposed between the coupling members 123 and the covering part 110, so that while the covering part 110 is being adjusted in position in the forward and backward directions and in the upward and downward directions, the reflection from the inner surface of the covering part 110 concentrates on the earhole EH.

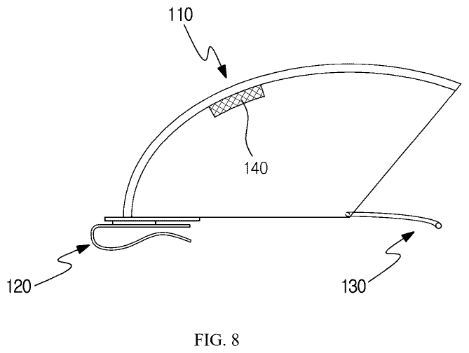

FIG. 8 is a sectional view showing a state where a wireless speaker 140 is mounted on the covering part 110 of the hearing aid for leisure sports according to the present disclosure.

As shown in FIG. 8, the hearing aid for leisure sports according to the present disclosure further includes the wireless speaker 140 disposed on the inner surface of the covering part 110.

The wireless speaker 140 performs a communication with an external device such as a smartphone paired therewith through a wireless communication module, and accordingly, even while the user is talking on the phone or listening to the radio or music, the user still can sense the user's surrounding traffic situations through sounds, thereby ensuring safe riding.

As described above, the hearing aid for leisure sports is configured to be easily worn on the user's ear, minimizing the noise generated by the wind blowing toward the user's face, which makes the user insensitive to other sound sources related to a traffic condition, and allowing sounds behind the user to be more clearly transmitted to the user's ear, to improve the user's auditory sensitivity to the visually unseen surrounding environments, so that the hearing aid for leisure sports ensures the user's road safety and reduces the user's exposure to avoidable accidents.

While the present disclosure has been described with reference to the particular, illustrative embodiments, it is not to be restricted by the embodiments but only by the appended claims. It is to be appreciated that those skilled in the art can change or modify the embodiments without departing from the scope and spirit of the present disclosure.

What is claimed is:

1. A hearing aid for leisure sports comprising:
a covering part having a concave accommodation space formed therein to accommodate a user's ear in such a way to allow a front-end portion facing the user's riding direction to be located in front of the user's ear, a covering part having an opening formed on a rear-end portion located over an ear to collect sound waves from behind the user to the accommodation space; and
a wearing part for fixing the covering part to the user's ear.

2. The hearing aid according to claim 1, wherein an inner surface of the covering part has a parabolic shape to reflect the sound waves onto a single focus that is set in position to correspond to the user's earhole.

3. The hearing aid according to claim 2, wherein the covering part is configured to allow the opening to be located on a space behind the user's earflap when the covering part is worn on the user's ear.

4. The hearing aid according to claim 1, wherein the covering part has a slant or streamlined curved shape on an outer surface to minimize the resistance of the wind blowing toward the user's face.

5. The hearing aid according to claim 1, wherein the covering part has the shape of a semi-dome on an outer surface thereof such that the front-end portion facing the user's riding direction thereof is curved and the rear-end portion thereof is open.

6. The hearing aid according to claim 1, wherein the wearing part has a first coupler for fixing the covering part to protective equipment worn on the user's body.

7. The hearing aid according to claim 6, wherein the first coupler has clips coupled to a fixing strap of a helmet worn on the user's body.

8. The hearing aid according to claim 7, wherein the clips are spaced apart from each other in up and down directions.

9. The hearing aid according to claim 7, wherein the first coupler further has position-adjusting members adapted to adjust the clips in position on the covering part in forward and backward directions.

10. The hearing aid according to claim 6, wherein the first coupler comprises soft coupling members each having a coupling hole fitted to a leg of glasses worn on the user's ear.

11. The hearing aid according to claim 1, wherein the wearing part comprises a second coupler for fixing the covering part to the user's earflap.

12. The hearing aid according to claim 11, wherein the second coupler comprises an elastic band whose both ends are connected to the top and bottom ends of the rear-end portion of the covering part.

13. The hearing aid according to claim 11, wherein the second coupler comprises a hook pivotably coupled to the top side of the rear-end portion of the covering part.

14. The hearing aid according to claim 1, further comprising a wireless speaker disposed on the inner surface of the covering part.
